(19) United States
(12) Patent Application Publication
(10) Pub. No.: US 2018/0324905 A1
(43) Pub. Date: Nov. 8, 2018

(54) ELECTROMAGNETIC WAVE HEATING DEVICE

(71) Applicant: IMAGINEERING, INC., Kobe (JP)

(72) Inventors: Yuji IKEDA, Kobe (JP); Seiji KANBARA, Kobe (JP); Yoshikazu SATOU, Kobe (JP)

(21) Appl. No.: 15/749,343

(22) PCT Filed: Aug. 1, 2016
(86) PCT No.: PCT/JP2016/072516

§ 371 Date: Jul. 5, 2018

(30) Foreign Application Priority Data
Jul. 31, 2015 (JP) 2015-151607

(51) Int. Cl. H05B 6/64; H05B 6/72; H05B 7/18

(52) U.S. Cl. CPC H05B 6/647; H05B 7/18; H05B 6/72

(57) ABSTRACT

To realize a reduction in size of an electromagnetic wave heating system that utilizes water vapor. The electromagnetic wave heating system comprises a heat chamber having a first wall surface and a second wall surface different from the first wall surface, in which an object is placed to be heated, a flat antenna arranged on the first wall surface of the heat chamber and configured to emit an electromagnetic wave so as to heat an object inside the heating chamber, a discharger arranged on the second wall surface and configured to generate a discharge plasma by occurring a high voltage through a resonation structure of the electromagnetic wave, and an oscillator formed by a semiconductor element and configured to output the electromagnetic wave, and it is configured that the electromagnetic wave outputted from the oscillator is supplied into the flat antenna and the discharger.

### TECHNICAL FIELD

The present invention relates to an electromagnetic wave heating system such as a microwave oven, and specifically relates to an electromagnetic wave heating system that heats food by using an array antenna for emitting an electromagnetic wave such as microwave and a discharger.

### BACKGROUND ART

In these days, the microwave oven that uses the microwave generation device by using semiconductor element instead of magnetron has been considered (for example, referring to Patent Document 1).

Moreover, recently, the cooking heater that performs to cook with superheated steam, has been developed and put into commercial reality. For example, in Patent Document 2, water stored in tank is heated up by the heater so as to generate boiling water vapor, the water vapor is delivered to the heating room by the fan, and also delivered to the second heater for generating the superheated steam by superheating the water vapor. The superheated steam generated by the second heater is also delivered to the heating room, and the heat cooking is performed by using the water vapor and the superheated steam.

### PRIOR ART DOCUMENTS

### Patent Document(s)

Patent Document 1: WO2010/032345

Patent Document 2: Unexamined patent application publication No. 2009-92376

### SUMARRY OF INVENTION

### Problem to be Solved by Invention

In Patent Document 2, the large sized fan for delivering the water vapor to the heating room, the pump for supplying water in tank into the heater, and two heaters, are required, and therefore, it is difficult to downsize the heat cooker for performing to heat by utilizing the water vapor.

The present invention is made from the above viewpoints.

An electromagnetic wave heating system of the present invention comprises a heat chamber having a first wall surface and a second wall surface different from the first wall surface, in which an object is placed to be heated, a flat antenna arranged on the first wall surface of the heat chamber and configured to emit an electromagnetic wave so as to heat an object inside the heat chamber, a discharger arranged on the second wall surface and configured to generate a discharge plasma by occurring a high voltage through a resonation structure of the electromagnetic wave, and an oscillator formed by a semiconductor element and configured to output the electromagnetic wave, and it is configured that the electromagnetic wave outputted from the oscillator is supplied into the flat antenna and the discharger.

### EFFECT OF INVENTION

An electromagnetic wave heating system of the present invention can be utilized for cooking such as food prepared with eggs that requires accurate and precise heat control, since heating by a low temperature plasma as well as normal electromagnetic wave heating can be performed. Moreover, the low temperature plasma is generated by using a discharger provided with an electromagnetic wave resonation structure, and therefore, a flat antenna for electromagnetic wave heating and an oscillator can be commonalized. Accordingly, the heating by the low temperature plasma can be performed without enlarging in size the electromagnetic wave heating system.

### BRIEF DESCRIPTION OF FIGURES

FIG. 1 shows a schematic structural view of a microwave oven of a first embodiment.

FIG. 2 shows the schematic structural view of a flat antenna regarding the microwave oven of the first embodiment.

FIG. 3 is a front view of the flat antenna of the first embodiment, (a) is the structure of a substrate on the front surface, and (b) is the structure of the substrate on the back surface.

FIG. 4 shows the schematic structural view of a discharger of the first embodiment.

FIG. 5 shows the schematic structural view of a discharger/injector of a second embodiment.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

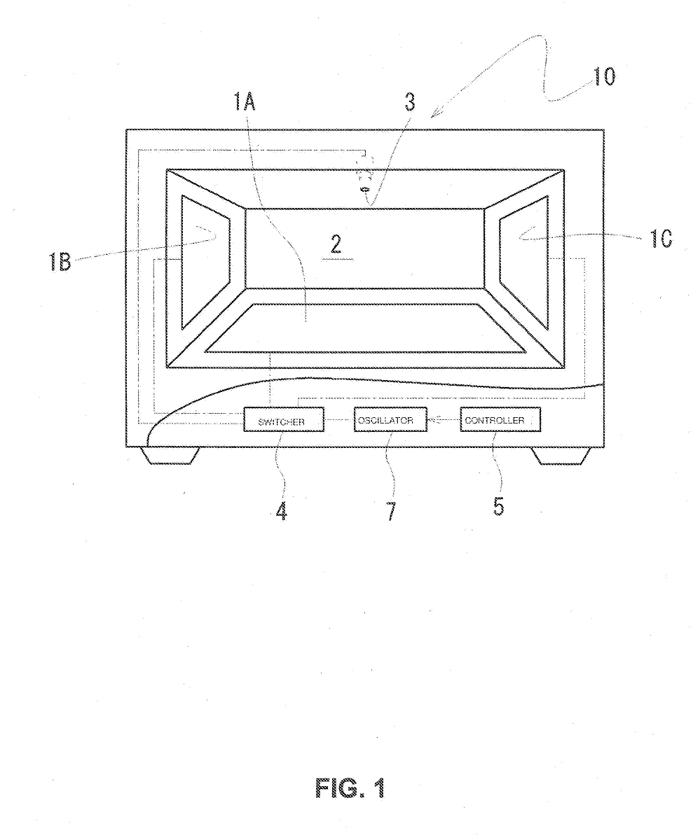

Referring to FIG. 1, a microwave oven 10 that is one example of an electromagnetic wave heating system of the present invention, comprises a heat chamber 2 for storing an object therein, flat antennas 1A to 1C arranged respectively on left, right wall surfaces and bottom surface of the heat chamber 2, a discharger 3, an oscillator 7 configured to generate a microwave, a switcher 4 configured to switch a supply destination of microwave inputted from the oscillator 7, a controller 5 configured to control the oscillator 7 and the switcher 4, and a coaxial line 6 that connects the switcher 4 with the respective flat antennas 1.

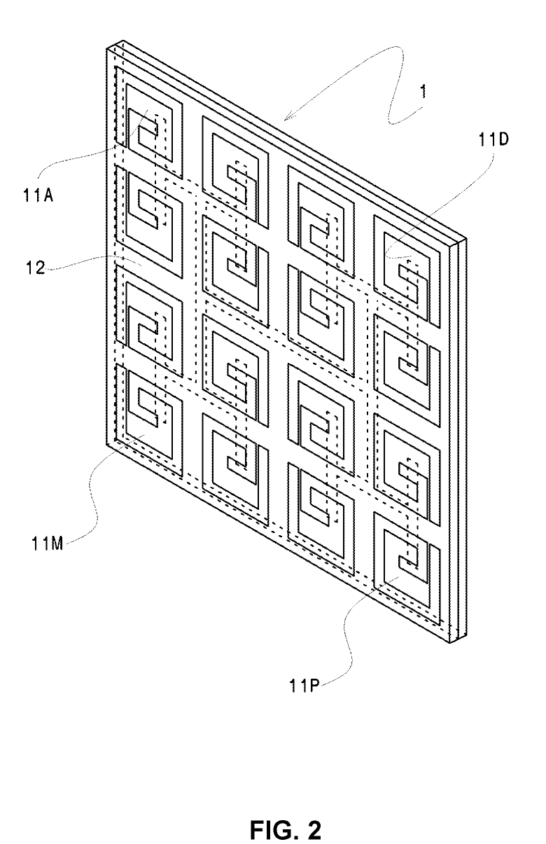

Referring to FIG. 2, regarding the respective flat antennas 1, sixteen small sized antennas 11A to 11P are arranged by four column×four row in an array manner. Each small sized antenna 11 is arranged so as to become equal in distance from/to the switcher 4.

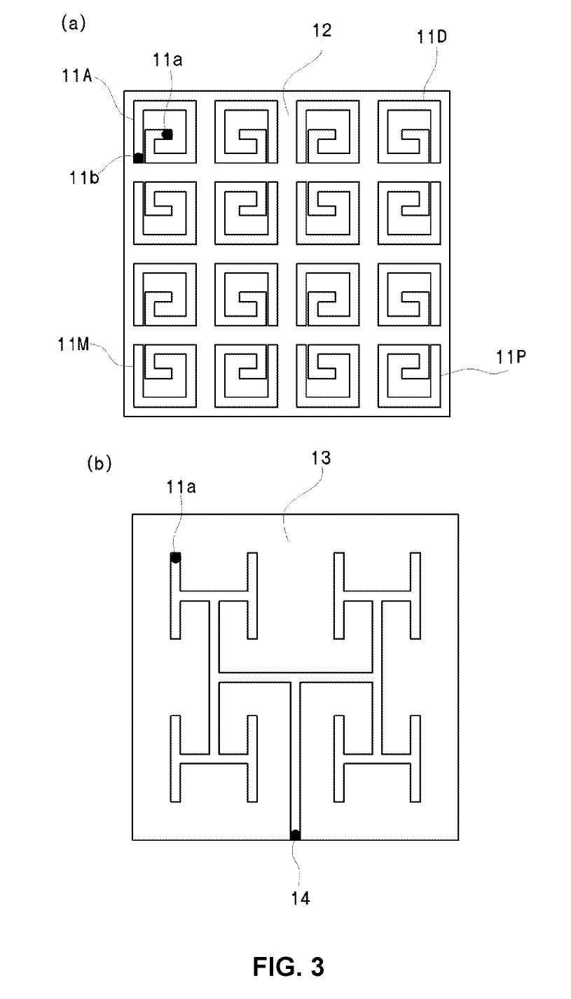

Referring to FIG. 3, the flat antenna 1 is formed by a first substrate 12 on the front surface side and a second substrate 13 on the back surface side.

The first substrate 12 is a substrate made of, for example, ceramics with insulation characteristics, and sixteen metal patterns formed in spiral manner are formed on the surface thereof. Each metal pattern functions as a small size antenna 11.

The second substrate 13 on the back surface includes a power feed point 14 formed at base configured to receive a microwave supply from the switcher 4. Further, the metal pattern for delivering microwave starting from the power feed point 14 to respective small antennas 11 is formed on the surface.

Each small sized antenna 11 is formed spirally at the center of a power receiving end 11a inputted of the microwave, and formed such that a distance from the power receiving end 11a to an opening end 11b becomes approximately ¼ wavelength of microwave. Moreover, a through hole is formed at the position of the power receiving end 11a of each small sized antenna 11 of the first substrate 12. A via is filled with in the through hole, and the metal pattern of the first substrate 12 is connected to the metal pattern of the second substrate 13 through the via.

Arrangement is performed such that the distance from the power feed point 14 to each power receiving end 11a of the corresponding antenna 11 in total number of sixteen, becomes equal. Accordingly, the sixteen antennas simultaneously becomes “ON” or “OFF” based on an output pattern from the oscillator 3 in principle since microwave in same phase is supplied into each of the sixteen antennas.

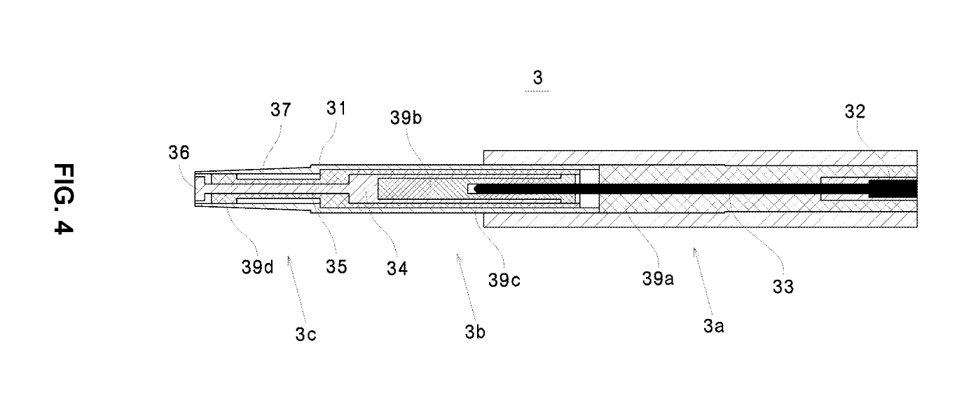

Referring to FIG. 4, the structure of a discharger 3 is explained in details. The discharger 3 comprises an input part 3a configured to receive microwave from the coaxial line 6, a coupling part 3b configured to attain an impedance matching between the coaxial line and the discharger 3, and a resonation part 3c configured to resonate microwave by a microwave resonation structure. A discharge electrode 36 is arranged at the distal end of the resonation part 3c. A conductive characteristic casing 31 thereinside stores respective members.

Microwave inputted from an input terminal 32 of the input part 3a is transmitted into the coupling part 3b by a first center electrode 33. A dielectric material 39a such as ceramics is provided between the first center electrode 33 and the casing 31.

The coupling part 3b is a part that attains an impedance matching between the coaxial line (for example, having 50Ω impedance) and the resonation part 3c (about 10Ω for example at microwave frequency band). A second center electrode 34 is formed in cylindrical manner provided with a bottom part at the resonation/discharge part 3c side, and the cylindrical part surrounds the first center electrode 33. The stick type first center electrode 33 opposes to the inner wall of the cylindrical second center electrode 34, and the microwave from the first center electrode 33 is transmitted to the second center electrode 34 by capacitively-coupling at the opposing part. The dielectric material 39b made of ceramics and etc. is filled with at the cylindrical part of the second center electrode 34, and the dielectric material 39c made of ceramics is also provided between the second center electrode 34 and the casing 31. A desired impedance matching can be attained by designing suitably length of these members and distance between members.

A third center electrode 35 of the resonation/discharge part 3c is connected to the second center electrode 34, and the microwave of the second center electrode 34 is transmitted into the third center electrode 35. The length of the third center electrode 35 is set to be approximately ¼ wavelength of microwave substantially. If it is designed such that a node of microwave is set at a position between the third center electrode 35 and the second center electrode 34, an anti-node of microwave becomes positioned at the distal end of the third center electrode 35, specifically at the discharge electrode 36, and as the result, the potential becomes largest. The dielectric material 39d, ceramics, is partially filled with between the third center electrode 35 and the casing 31. Here, it is better to fill ceramics with from the viewpoint of mechanical strength securing for the discharger 3; however, if the potential, so called Q factor of the discharger 3 is aimed to be enhanced, it is better not to fill ceramics with. Accordingly, these “trade-off” are taken into account, and the ceramics is partially filled with at the discharger 3.

According to the discharger 3, when the microwave lkW is supplied from the input part 3a, some tons KV of high voltage occurs between the discharge electrode 36 and the casing 31, and the discharge is caused between the discharge electrode 36 and the casing 31. Since the discharge plasma can be generated by the discharge, food heat cooking by the low temperature plasma can be achieved by utilizing the discharger 3 to the microwave oven 10.

Note that, the discharger 3 uses a microwave resonation structure, and therefore, discharging in series can be performed. Since the discharger 3 differs in this point from many types of dischargers such as spark plug that has no choice but to perform intermittent discharge, it can be said that the discharger 3 is suitable for the heat cooker such as microwave oven.

Moreover, the discharger 3 causes high voltage by using microwave generated in the oscillator 7. The oscillator 7 also functions as a power source of microwave irradiated from the flat antenna 1. Accordingly, both low temperature plasma generation and microwave heating can be achieved only by one oscillator 7.

### Second Embodiment

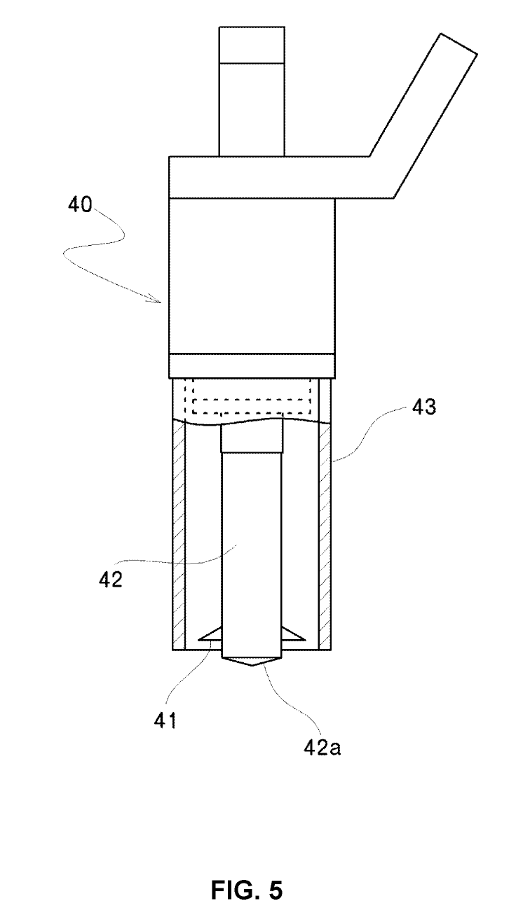

In replace of the above discharger 3, an injector/discharger 40 illustrated in FIG. 5 can also be used. The injector/discharger 40 comprises an injection pipe 42, an annular protrusion 41 provided at the tip end of the injection pipe 42, and a cylindrical member 43 that surrounds the injection pipe 42. The injection pipe 42 injects the water vapor from an injection port 42a provided at the tip part. The microwave resonation structure is formed at an outside of the injection pipe 42, and as well as the discharger 3, the microwave from the oscillator 7 is boosted. A microwave resonation circuit formed on the surface of the injection pipe 42 is designed so as to be the wavelength becomes ¼ wavelength of microwave in length and such that the anti-node of microwave is positioned at a part provided with the annular protrusion 41. Then, when microwave with a predetermined power or above is fed from the oscillator 7 to the injector/discharger 40, the potential difference between the annular protrusion 41 and the cylindrical member 43 is increased, and the breakdown (discharge) occurs there.

By using together the injector/discharger 40 and the above flat antenna 1, the below cooking way is considered. Firstly, the temperatures of food and the heat chamber on which the food is put, are warmed up by microwave heating. Under th situation, heating suitable for eggs and dairy products that requires, for example, a delicate heat control can be performed by injecting the water vapor from the injection pipe 42 and further generating the discharge plasma.

### INDUSTRIAL APPLICABILITY

As explained as above, the present invention is effective to an electromagnetic wave heating system such as a microwave oven.

### NUMARAL SYMBOLS EXPLANATION

1. Flat Antenna
2. Heat Chamber
3. Discharger
4. Switcher
5. Controller
6. Coaxial Line
7. Oscillator
11. Small-sized Antenna
12. First Substrate
13. Second Substrate
14. Power Feed Point

1. An electromagnetic wave heating system comprising:
a heat chamber having a first wall surface and a second wall surface different from the first wall surface, in which an object is placed to be heated;
a flat antenna arranged on the first wall surface of the heat chamber and configured to emit an electromagnetic wave so as to heat the object inside the heat chamber;
a discharger arranged on the second wall surface and configured to generate a discharge plasma by occurring a high voltage through a resonation structure of the electromagnetic wave; and
an oscillator formed by a semiconductor element and configured to output the electromagnetic wave,
wherein it is configured that the electromagnetic wave outputted from the oscillator is supplied into the flat antenna and the discharger.
